(19) United States
(12) Patent Application Publication
(10) Pub. No.: US 2025/0085242 A1
(43) Pub. Date: Mar. 13, 2025

(54) THERMAL CONDUCTIVITY MEASUREMENT BASED ON PHASE CHANGE MATERIALS

(71) Applicant: General Atomics, San Diego, CA (US)

(72) Inventors: Jiping Zhang, San Diego, CA (US); Arthur Blacklock, San Diego, CA (US)

(21) Appl. No.: 18/466,225

(22) Filed: Sep. 13, 2023

(51) Int. Cl. G01N 25/04; G01N 25/18

(52) U.S. Cl. CPC G01N 25/04; G01N 25/18

(57) ABSTRACT

The disclosed technology can be implemented to provide a method of determining a thermal conductivity of a sample. The method includes controlling a thermal source to increase a temperature of the thermal source to an elevated temperature above a phase change temperature of a phase change material, placing the sample between and in thermal contact with the phase change material below the phase change temperature and the thermal source to allow a thermal conduction from the thermal source to the phase change material through the sample to increase an initial temperature of the phase change material to the phase change temperature to cause the phase change material to transition from a first phase to a second phase, performing a measurement on at least one of the sample or the phase change material, and determining the thermal conductivity of the sample based on the measurement.

### TECHNICAL FIELD

This patent document relates to methods and systems for thermal conductivity measurement.

### BACKGROUND

The thermal conductivity of a material is an important material property in various applications for incorporating the material into structures, devices or systems where thermal management is needed.

### SUMMARY

This patent document includes a technology and its implementations for providing methods and systems using phase change materials for thermal conductivity measurements of samples in various shapes and configurations, including, for example, planar or non-planar samples that may or may not have roughened surfaces suitable for use in various applications, including for uses in a nuclear reactor environment and other applications requiring high temperature performances for various temperature ranges. This method accommodates samples that may have arbitrary surface roughness, and samples that may be composed of heterogeneous materials, such as composites.

In one aspect, the disclosed technology can be implemented to provide a method of determining a thermal conductivity of a sample. The method includes controlling a thermal source to increase a temperature of the thermal source to an elevated temperature above a phase change temperature of a phase change material, placing the sample between and in thermal contact with the phase change material at an initial temperature below the phase change temperature and the thermal source at the elevated temperature to allow a thermal conduction from the thermal source to the phase change material through the sample to increase the initial temperature of the phase change material to the phase change temperature to cause the phase change material to transition from a first phase to a second phase at the phase change temperature, performing a measurement on at least one of the sample or the phase change material, and determining the thermal conductivity of the sample based on the measurement.

In an embodiment, the phase change material maintains the phase change temperature for a first phase transition period to transition from the first phase to the second phase.

In an embodiment, the thermal source is at a constant temperature that is equal to or below the elevated temperature during the first phase transition period and for at least a second phase transition period longer than the first phase transition period.

In an embodiment, the method further includes shaping the phase change material to conform to a shape of the sample, which may be a simple or complex shape, to ensure good thermal contact with the sample and accuracy in determining the thermal conductivity of the sample.

In an embodiment, the phase change material has a curved shape to conform to a curved shape of the sample to ensure good thermal contact with the sample and accuracy in determining the thermal conductivity of the sample.

In an embodiment, the step of performing the measurement on the at least one of the sample or the phase change material includes measuring the first phase transition period for the phase change material between a first time when at least a portion of the phase change material transitions from the first phase to the second phase, and a second time when substantially all the phase change material transitions to the second phase, and wherein the thermal conductivity of the sample is determined by:

$$k = \frac{{m}_{1} {H}_{1} h}{A ( {T}_{2} - {T}_{1} ) t} ,$$

where k is the thermal conductivity of the sample, m₁ is a mass of the phase change material, H₁ is a latent heat of the phase change material, h is a thickness of the sample, A is an area of the sample, T₁ is the phase change temperature of the phase change material, T₂ is a constant temperature of the thermal source when the phase change material transitions from the first phase to the second phase at the phase change temperature, and t is the first phase transition period for the phase change material to transition from the first phase to the second phase.

In an embodiment, the sample is a solid material sample having a tube shape and the phase change material is shaped to include a portion that is in contact with and conforms to the tube shape at a contact location of the solid material sample.

In an embodiment, the thermal conductivity of a tube sample is determined by:

$$k = \frac{ρ {r}_{i}^{2} Hln ( \frac{{r}_{o}}{r i} )}{2 ( {T}_{2} - {T}_{1} ) t} ,$$

where k is the thermal conductivity of the sample, p is a density of the phase change material, H is a latent heat of the phase change material, rᵢ is an inner radius of the curved shape of the sample, rₒ is an outer radius of the curved shape the sample, T₁ is the phase change temperature of the phase change material, T₂ is a constant temperature of the thermal source when the phase change material transitions from the first phase to the second phase at the phase change temperature, and t is the first phase transition period for the phase change material to transition from the first phase to the second phase.

In an embodiment, the sample is a liquid or gas and is directed to flow in a fluid conduit between and in thermal contact with the thermal source and the phase change material.

In an embodiment, the thermal source includes a second phase change material having a second phase change temperature.

In an embodiment, the method further includes placing a reference structure between the sample and one of the thermal source and the phase change material in a way that the reference structure is in thermal contact with the sample and the one of the thermal source and the phase change material, and measuring a reference temperature of the reference structure during the first phase transition period to determine a thermal conductivity of the sample between the reference temperature of the reference structure and either the phase change temperature of the phase change material or the constant temperature the thermal source during the first phase transition period of the phase change material.

In an embodiment, the method further includes placing a first reference structure in thermal contact with the sample and between the sample and the phase change material, placing a second reference structure between the sample and the thermal source to be in thermal contact with the sample and the thermal source, and measuring a first reference temperature of the first reference structure and a second reference temperature of the second reference structure to determine a thermal conductivity of the sample between the first reference temperature of the first reference structure and the second reference temperature of the second reference structure.

In an embodiment, the thermal conductivity of the sample between the first reference temperature and the second reference temperature is determined by one of following expressions:

$$k = \frac{{k}_{r 2} ( {T}_{2} - {T}_{r 2} ) h}{{h}_{r 2} ( {T}_{r 2} - {T}_{r 1} )} , k = \frac{{k}_{r 1} ( {T}_{r 1} - {T}_{1} ) h}{{h}_{r 1} ( {T}_{r 2} - {T}_{r 1} )} , or k = \frac{mHh}{A ( {T}_{r 2} - {T}_{r 1} ) t} ,$$

where k is the thermal conductivity of the sample, kᵣ₁ is a thermal conductivity the first reference structure, kᵣ₂ is a thermal conductivity of the second reference structure, m is a mass of the phase change material, H is a latent heat of the phase change material, A is an area of the sample, h is a thickness of the sample, hᵣ₁ is a thickness of the first reference structure, hᵣ₂ is a thickness of the second reference structure, T₁ is the phase change temperature of the phase change material, T₂ is the constant temperature of the thermal source, Tᵣ₁ is a temperature of an interface between the first reference structure and the sample, Tᵣ₂ is a temperature of an interface between the second reference structure and the sample, and t is the first phase transition period for the phase change material to transition from the first phase to the second phase.

In another aspect, the disclosed technology can be implemented to provide a system of determining a thermal conductivity of a sample. The system includes a phase change material configured to transition from a first phase to a second phase at a phase change temperature, a thermal source configured to maintain a constant temperature higher than the phase change temperature, the phase change material and the thermal source being placed on different sides of the sample to allow a thermal conduction from the thermal source to the phase change material and cause the phase change material to transition from the first phase to the second phase, one or more sensors coupled to the phase change material and configured to perform a measurement on at least one of the sample or the phase change material, and a processor coupled to the one or more sensors and configured to determine the thermal conductivity of the sample based on at least the measurement on the at least one of the sample and the phase change material.

In an embodiment, at least one of the thermal source or the phase change material has a shape that conforms to a shape of the sample to ensure good thermal contact with the sample and accuracy in determining the thermal conductivity of the sample.

In an embodiment, one of the thermal source or the phase change material has a cylinder shape.

In an embodiment, the thermal source is a second phase change material having a second phase change temperature equal to the constant temperature.

In yet another aspect, the disclosed technology can be implemented to provide a method of determining a thermal conductivity of a sample. The method includes shaping a first phase change material to conform to a shape of the sample to ensure good thermal contact with the sample and accuracy in determining the thermal conductivity of the sample; placing the sample and the first phase change material each in a solid phase to be in thermal contact with a second phase change material in a liquid phase to allow thermal conduction from the second phase change material to the first phase change material and to cause the first phase change material to transition from the solid phase to the liquid phase; measuring a duration for the first phase change material between a first time when at least a portion of the first phase change material transitions from the solid phase to the liquid phase and a second time when substantially all the first phase change material transitions to the liquid phase; and determining the thermal conductivity of the sample based on at least the duration.

In an embodiment, the step of shaping the first phase change material to conform to the shape of the sample includes supplying heat to the first phase change material having a first melting point and the second phase change material having a second melting point higher than the first melting point to melt the first phase change material and the second phase change material each to the liquid phase; and placing at least a portion of the first phase change material in the liquid phase to the sample so that when cooled down the first phase change material transitions from the liquid phase to the solid phase and is combined with the sample.

In an embodiment, the thermal conductivity of the sample between the first melting point and the second melting point is determined by:

$$k = \frac{{m}_{1} {H}_{1} h}{A ( {T}_{2} - {T}_{1} ) t} ,$$

where k is the thermal conductivity of the sample, m₁ is a mass of the first phase change material, H₁ is a latent heat of the first phase change material, h is a thickness of the sample, A is an area of the sample, T₁ is the first melting point of the first phase change material, T₂ is the second melting point of the second phase change material, and t is the measured duration for the first phase change material to transition from the solid phase to the liquid phase.

In an embodiment, the first phase change material is Tin (Sn), lead (Pb), bismuth (Bi), a eutectic copper-silver (Cu—Ag) alloy, silver (Ag), cooper (Cu), or Silicon (Si).

The above and other aspects and their implementations are described in greater detail in the drawings, the description and the claims.

### BRIEF DESCRIPTION OF THE DRAWINGS

FIG. 1 is a flowchart for an example method of measuring a thermal conductivity of a sample.

FIG. 2 depicts a schematic diagram showing a basic principle of a thermal conduction from a hot media to a cold media through a sample.

FIG. 3 shows an example of a thermal conductivity measurement system including a phase change material and a thermal source.

FIG. 4 shows a table including some examples of phase change materials that may be used in a thermal conductivity measurement system.

FIG. 5A shows an example of temperature changes with respect to time for a phase change material (in a solid line) and a thermal source (in a dash-dotted line) of a thermal conductivity measurement system.

FIGS. 5B-5C show examples of temperature changes with respect to time for a first phase change material (in a solid line) and a second phase change material (in a dash-dotted line) of a thermal conductivity measurement system.

FIG. 6 shows an example of a thermal conductivity measurement system including two different phase change materials.

FIGS. 7A and 7B show two different example thermal conductivity measurement systems for measuring a thermal conductivity of a sample having a curved shape.

FIG. 8 is a flowchart for an example method of measuring a thermal conductivity of a sample using two different phase change materials.

FIG. 9A shows an example of a furnace configured to provide heat to a phase change material to transition from a lower energy phase (e.g., solid) to a higher energy phase (e.g., liquid).

FIG. 9B shows an example thermal conductivity measurement system including two different phase change materials.

FIGS. 10A-10D depict different examples of adjusting a temperature range for which a thermal conductivity of a sample is determined.

FIG. 11 is a schematic diagram of an example thermal conductivity measurement system configured to determine a thermal conductivity of a solid material sample having a tube structure.

FIG. 12 is a schematic diagram of an example thermal conductivity measurement system configured to determine a thermal conductivity of a liquid or gas sample contained in a fluid conduit of the thermal conductivity measurement system.

FIG. 13 shows an example of a hardware platform configured to implement some of the methods described in the present disclosure.

### DETAILED DESCRIPTION

Various structures, such as heat exchangers, nozzles, nosecones, airframes, nuclear fusion reactor flow channel inserts, and nuclear cladding walls, and some special liquids and gasses may be used for various heat transfer applications that require high temperature performance. Before mass production or real use of these various structures and special liquids and gasses, it is desirable to simulate and measure their thermal conductivities for different temperature ranges required by the applications. For example, various nuclear reactors use a fissile material as the fuel to generate power. The fuel is usually held in a robust physical form (such as fuel rods) capable of enduring high stresses, elevated operating temperatures, and an intense neutron radiation environment. Fuel structures need to maintain their shape and integrity over a period (e.g., several years) within the reactor core, thereby preventing the leakage of fission products into the reactor coolant. The thermal conductivity of the fuel rod is an important parameter in selecting the fuel rod materials and designing the fuel rods.

A low thermal conductivity and a complex shape of a sample, as common for many of the structures and the special liquids and gasses discussed above, make it technically challenging to determine the thermal conductivity of such sample accurately using existing methods. Further, various existing thermal conductivity measurement methods may be applied to planar samples, but often must apply factors to correct for samples of non-planar geometry or surface roughness, limiting their use and accuracy. Additionally, some thermal conductivity measurement methods often use a localized probe that may not be adequate for obtaining bulk measurements of materials composed of spatially distributed or heterogeneous material components or constituents because the probe size may not adequately average over the internal heterogeneous material components, for example, in the case of a laser spot size in a laser flash system that does not adequately sample the volume of the sample material components. The disclosed technology provides methods and systems for performing an accurate thermal conductivity measurement on the sample in a complex shape (for example, a curved shape, multi-curvature shape, a tube shape, or other complex geometries) and, in some applications, the sample to be measured may have a low thermal conductivity. The technology disclosed in this patent document is in part based on the recognition that a phase change material maintains at its phase change temperature when undergoing a phase change or transition from one phase to another. This constant temperature during the phase change can be used as a stable reference temperature in measuring the thermal conductivity of a sample while transferring heat to or from a sample to enable measurement of the thermal conductivity of the sample.

In some implementations of the disclosed technology, a method of determining a thermal conductivity of a sample is provided by using one or more phase change materials. The method includes controlling a thermal source to increase a temperature of the thermal source to an elevated temperature above a phase change temperature of a phase change material, placing the sample between and in thermal contact with the phase change material at an initial temperature below the phase change temperature and the thermal source at the elevated temperature to allow a thermal conduction from the thermal source to the phase change material through the sample to increase the initial temperature of the phase change material to the phase change temperature to cause the phase change material to transition from a first phase to a second phase at the phase change temperature, performing a measurement on at least one of the sample or the phase change material, and determining the thermal conductivity of the sample based on the measurement.

In some implementation of the disclosed technology, a system of determining a thermal conductivity of a sample is provided. The system includes a phase change material configured to transition from a first phase to a second phase at a phase change temperature, a thermal source configured to maintain a constant temperature higher than the phase change temperature, the phase change material and the thermal source being placed on different sides of the sample to allow a thermal conduction from the thermal source to the phase change material and cause the phase change material to transition from the first phase to the second phase, one or more sensors coupled to the phase change material and configured to perform a measurement on at least one of the sample or the phase change material, and a processor coupled to the one or more sensors and configured to determine the thermal conductivity of the sample based on at least the measurement on the at least one of the sample and the phase change material.

In some implementation of the disclosed technology, a method of determining a thermal conductivity of a sample is provided. The method includes shaping a first phase change material to conform to a shape of the sample to ensure good thermal contact with the sample and accuracy in determining the thermal conductivity of the sample; placing the sample and the first phase change material each in a solid phase to be in thermal contact with a second phase change material in a liquid phase to allow thermal conduction from the second phase change material to the first phase change material and to cause the first phase change material to transition from the solid phase to the liquid phase; measuring a duration for the first phase change material between a first time when at least a portion of the first phase change material transitions from the solid phase to the liquid phase and a second time when substantially all the first phase change material transitions to the liquid phase; and determining the thermal conductivity of the sample based on at least the duration.

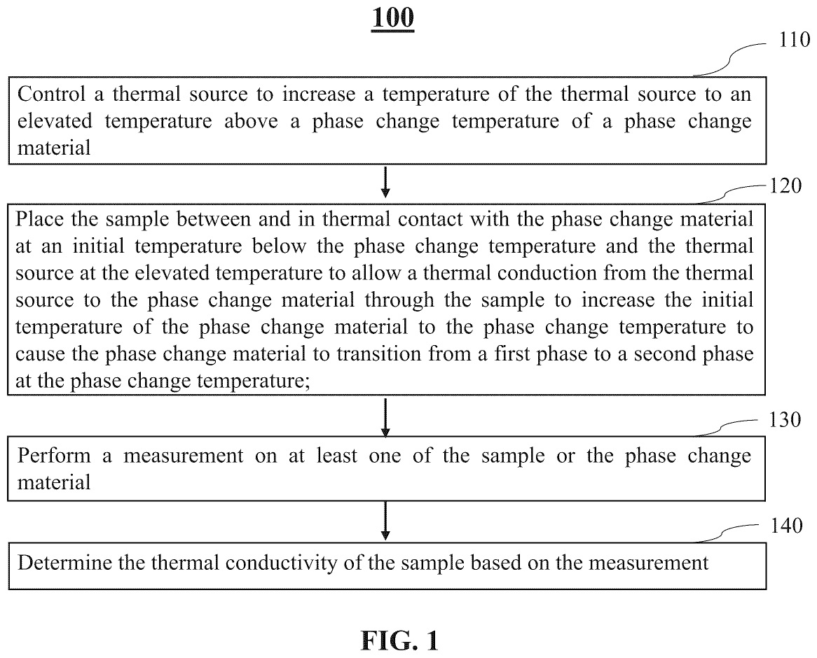

FIG. 1 is a flowchart for an example method 100 of measuring a thermal conductivity of a sample. In an embodiment, the sample may have a low thermal conductivity, for example, lower than that of the phase change material used in the measurement device. In an embodiment, the sample is a solid having any shape or structure. In some embodiments, the sample may be made of general monolithic materials. In some embodiments, the sample may be a composite having heterogeneous, internal structures. For example, the sample may include a fiber, a matrix, a void, or any combination thereof. In some embodiments, the sample may have a planar geometry. In some embodiments, the sample may have a non-planar geometry. In some embodiments, the sample may have a regular shape. For example, the sample may be a plate or a tube. In some embodiments, the sample may have a uniform or a non-uniform structure. For example, the sample may have a porous structure, such as a foam structure. In some embodiments, the sample may have a very complex, non-regular structure. In an embodiment, the sample may be a porous foam flow channel insert. In an embodiment, the sample may be a silicon carbide composite nuclear fuel cladding tube. In an embodiment, the sample is a liquid or a gas to be placed within a thermal conductive container having any suitable shape or structure. In an embodiment, the sample is a nuclear fusion reaction flow channel insert. In an embodiment, the sample is a nuclear cladding wall. In an embodiment, the sample is made of a heat exchange material. In an embodiment, the sample has a curved shape or a multi-curvature shape.

At step 110, a thermal source is controlled to increase a temperature of the thermal source to an elevated temperature above a phase change temperature of a phase change material. In some embodiment, the phase change material and the thermal source may be the phase change material 310, 710, 1010, 1110 and the thermal source 340, 740, 1040, 1140. In an embodiment, step 110 may be implemented by a furnace, for example, the furnace 900 that supplies heat to increase the temperature of the thermal source to the elevated temperature. In an embodiment, the furnace, for example, the furnace 900 may be used to increase the temperature of the thermal source to a temperature higher than the elevated temperature, and the thermal source may be further cooled down to the elevated temperature. In an embodiment, thermal source, when in use, may be configured to increase its temperature to the elevated temperature and maintain itself at the elevated temperature. The elevated temperature is above the phase change temperature of the phase change material to allow thermal conduction from the thermal source to the phase change material as discussed in greater details below. The phase change temperature of the phase change material may be a melting point or a boiling point of the phase change material.

At step 120, the sample is placed between and in thermal contact the phase change material and the thermal source. In some embodiment, the sample may be the samples 230, 330, 730, 1030, 1130, and 1230. The sample is in thermal contact with the phase change material and the thermal source to allow a thermal conduction between the sample and the phase change material and between the sample with the thermal source each from one having a higher temperature to the other one having a lower temperature. In an embodiment, the phase change material has an initial temperature below the phase change temperature before step 120 is implemented. Because the thermal source has a higher temperature than the phase change material, a thermal conduction occurs from the thermal source to the phase change material through the sample to increase the temperature of the phase change material to the phase change temperature to cause the phase change material to transition from a first phase to a second phase at the phase change temperature. The phase change temperature may also be referred to as a first temperature and is denoted by T₁. In an embodiment, the first phase is a lower energy phase and the second phase is a higher energy phase. The words of “lower” and “higher” are both relative terms between the first phase and the second phase corresponding to a corresponding phase change temperature. For example, the first phase may be a solid and the second phase may be a liquid. Accordingly, the phase change temperature is a melting point of the phase change material. The solid phase is the lower energy phase and the liquid phase is the higher energy phase corresponding to the melting point of the phase change material. As another example, the first phase may be a liquid, and the second phase may be a gas. Accordingly, the phase change temperature is a boiling point of the phase change material. The liquid phase is the lower energy phase and the gas phase is the higher energy phase corresponding to the boiling point of the phase change material.

In an embodiment, the thermal source is a second phase change material that maintains the second phase change temperature while experiencing a phase change. In an embodiment, the second phase change material is the second phase change material 640, 745, 1045. In an embodiment, the second phase change material maintains at a second phase change temperature while transitioning from a higher energy phase to a lower energy phase during the measurement. The second phase change temperature may also be referred to as a second temperature and is denoted by T₂. In an embodiment, the first temperature T₁ is lower than the second temperature T₂. For example, the second phase change material transitions from a liquid to a solid. Accordingly, the second phase change temperature is the melting point of the second phase change material. As another example, the second phase change material transitions from a gas to a liquid. Accordingly, the second phase change temperature is the boiling point of the second phase change material. In an embodiment, the second phase change material is not coupled to a controlled heater. Accordingly, the thermal source can maintain the second temperature during the phase transition period of the second phase change material. As discussed in greater details below, the phase transition period of the second phase change material must be longer than that of the phase change material.

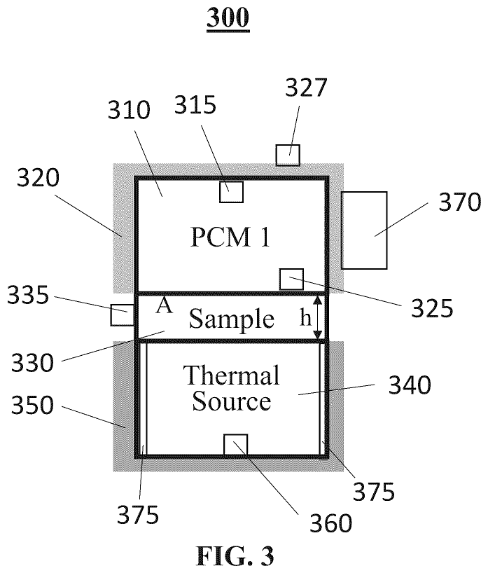

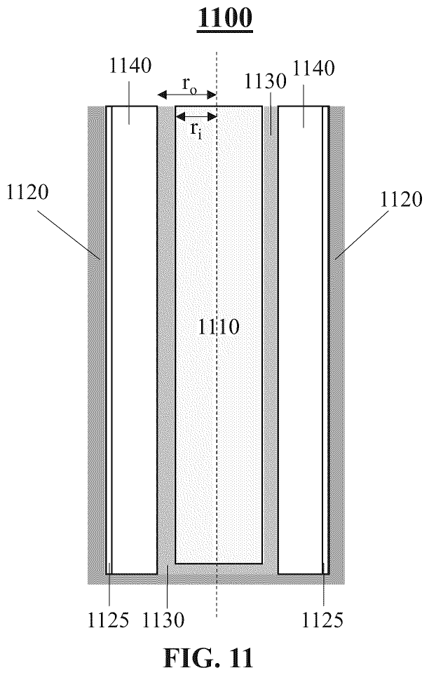

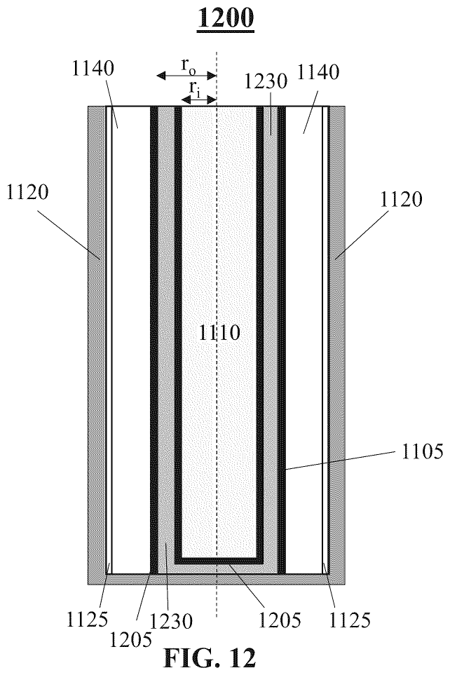

In an embodiment, the thermal source includes a controlled heater. For example, the controlled heater may be substantially similar to the controlled heater 375 in FIG. 3 or the controlled heater 1125 in FIGS. 11 and 12. In an embodiment, the controlled heater includes control circuit (e.g., a feedback loop circuit) that causes the thermal source to rise the temperature to the second temperature T₂ when started and maintain at the second temperature T₂ when in operation. An example of the thermal source may include a control circuit, for example, a feedback loop circuit, coupled with the second phase change material to maintain the second temperature for the thermal source by supplying heat to the second phase change material when its temperature departs from the second temperature within a predetermined range. In this embodiment, the second phase change material may not experience a phase transition while maintaining the second temperature. In some examples, the second temperature is greater than the second phase change temperature as discussed above. In an embodiment, the controlled heater is a heating tape. In an embodiment, the second phase change material is coupled with the controlled heater that compensates the heat loss of the second phase change material and causes the second phase change material to remain in the phase transition process at the second temperature for a relatively long period of time.

At step 130, a measurement is performed on at least one of the sample or the phase change material. For example, a measurement of the temperature of the sample is performed when both the phase change material and the thermal source have a constant temperature. In an embodiment, a measurement of a first phase transition period during which the phase change material experiences a phase change is performed. In some embodiments, one or more dimensions of the sample, such as a thickness and a cross section area of the sample, are measured. In an embodiment, the measurement is performed by one or more sensors similar to the first temperature sensor 315, the second temperature sensor 335, the third temperature sensor 360, the timer 327, and the phase detector 325 in FIG. 3.

At step 140, the thermal conductivity of the sample is determined based on at least the measurement implemented at step 130. In some embodiments, the thermal conductivity of the sample is determined for a temperature range between the different constant temperatures of the phase change material (the first temperature) and the thermal source (the second temperature).

In some embodiments, the method 100 is implemented to determine the thermal conductivity of the sample for a specific temperature range for various applications. In some embodiments, the first temperature and the second temperature correspond to the lower bound and the higher bound of the temperature range, respectively. Accordingly, the phase change material and/or the thermal source at step 120 are selected based on the first temperature and the second temperature corresponding to the specific temperature range requirement. For example, the sample may be a part (e.g., a nuclear cladding) to be used in a light water reactor operating at 250° C.-350° C. To approximate this temperature range for which the thermal conductivity of the sample is determined, the first phase material and/or the thermal source may be bismuth (Bi) having a melting point of 271° C. or lead (Pb) having a melting point of 327° C. In an embodiment, the phase change material is bismuth (Bi), and the thermal source is lead (Pb). As another example, the sample may be a nuclear cladding to be used in a modular reactor operating at 700° C.-900° C. To approximate this temperature range for which the thermal conductivity of the sample is determined, the phase change material and/or the thermal source may be a eutectic copper-silver (Cu—Ag) alloy having a melting point of 779° C. As another example, the thermal conductivity of a sample may be required to be determined and evaluated at the event of an accident with high temperature of over 900° C. As such, the first phase material and/or the thermal source may be silver (Ag) having a melting point of 962° C., copper (Cu) having a melting point of 1083° C., silicon (Si) having a melting point of 1414° C., or any combination thereof. As another example, the sample may be a flow channel insert wall structure for nuclear fusion coolant flow application operating at 300-700° C. To approximate this temperature range for which the thermal conductivity of the sample is determined, the phase change material and/or the thermal source may be Tin (Sn) having a melting point of 232° C. or aluminum (Al) having a melting point of 660° C. In an embodiment, the phase change material is Tin (Sn) and the thermal source is Al. Sometimes, it is desirable to determine the thermal conductivity of the sample at a specific temperature. Accordingly, the first phase material may have a phase change temperature at or close to the specific temperature. Further, the thermal source may be a different phase change material having a similar, but different phase change temperature than the phase change temperature. Alternatively, or in addition, the thermal source may be a heater configured to maintain the specific temperature with or without including a phase change material.

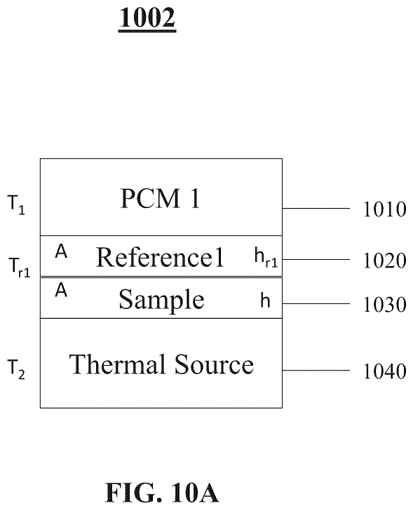

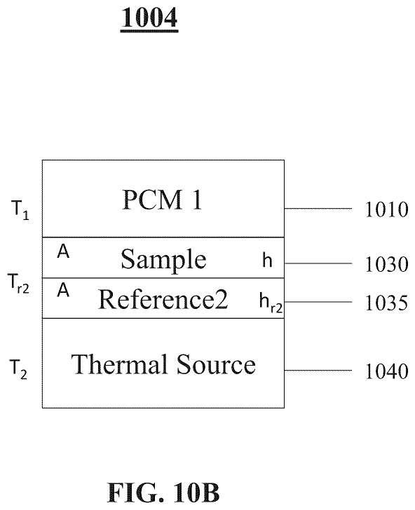

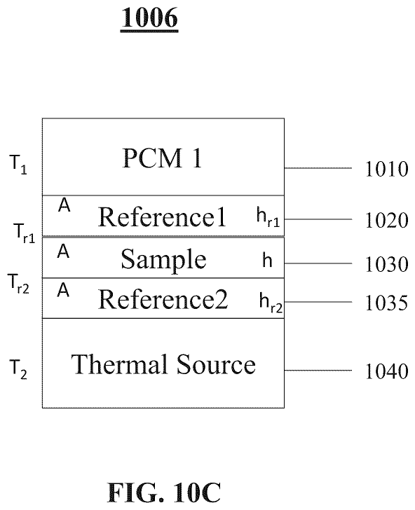

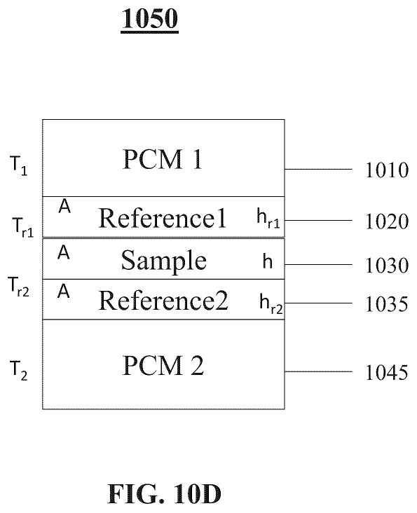

In some embodiments, the temperature range for which the thermal conductivity of the sample is determined can be adjusted by inserting one or more reference structures as described in greater details associated with FIGS. 10A-10D.

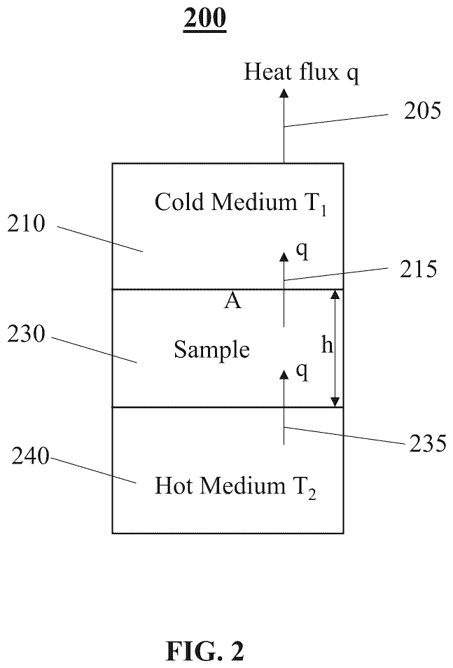

FIG. 2 depicts a schematic diagram 200 showing a basic principle of a thermal conduction from a hot medium 240 to a cold medium 210 through a sample 230. The words of “hot” and “cold” are relative terms, merely meaning a temperature of the cold medium 210 (T₁) is lower than a temperature of the hot medium 240 (T₂). When both T₁ and T₂ are constant, the heat flux between the cold medium 210 and the hot medium 240, as shown as 205, 215, and 235 in FIG. 2, is constant. The heat flux 205, 215, and 235 can be expressed by:

$$q = \frac{k A ( {T}_{2} - {T}_{1} )}{h} \qquad ( 1 )$$

where q is a constant heat flux 205, 215, and 235, k is a thermal conductivity of the sample 230 for the temperature range between T₁ and T₂, h is a thickness of the sample 230, A is a cross section area of the sample 230. T₁ is a first temperature maintained by the cold medium 210, and T₂ is a second temperature maintained by the hot medium 240.

By re-arranging the terms in equation (1), the thermal conductivity, k, of the sample 230 for the temperature range between T₁ and T₂ is obtained as:

$$k = \frac{qh}{A ( {T}_{2} - {T}_{1} )} \qquad ( 2 )$$

FIG. 3 shows an example of a thermal conductivity measurement system 300. The thermal conductivity measurement system 300 may be used to implement method 100 to determine a thermal conductivity of the sample 330. As shown, the thermal conductivity measurement system 300 includes a phase change material 310 and a thermal source 340. The thermal conductivity measurement system 300 further includes a first insulator 320 outside the phase change material 310 and a second insulator 350 outside the thermal source 340 to prevent heat loss and maintain a directional heat conduction from the thermal source 340 to the phase change material 310. In an embodiment, the first insulator 320 is provided outside a first container enclosing the phase change material 310, and the second insulator 350 is provided outside a second container enclosing the thermal source 340. In an embodiment, the phase change material 310 is the cold medium 210 in FIG. 2, and the thermal source 340 is the hot medium 240 in FIG. 2. The thermal conductivity measurement system 300 also includes one or more sensors 315, 325, 327, 335 and 360 to perform one or more measurements, for example at step 130 of method 100 in FIG. 1. For example, the thermal conductivity measurement system 300 may include a first temperature sensor 315 configured to measure and monitor the temperature of the phase change material 310, a second temperature sensor 335 configured to measure and monitor the temperature of the sample 330, and a third temperature sensor 360 configured to measure and monitor the temperature of the thermal source 340. The thermal conductivity measurement system 300 may include a timer 327 configured to measure a phase transition period for the phase change material 310 during which the phase change material 310 experiences a phase change. Specifically, the time 327 is configured to measure the phase transition period between a first time when at least a portion of the phase change material 310 transitions from a first phase (e.g., a lower energy phase) to a second phase (e.g., a higher energy phase), and a second time when substantially all the phase change material 310 transitions to the second phase (e.g., the higher energy phase) Optionally, the thermal conductivity measurement system 300 may include a phase detector 325 configured to detect a current phase (i.e., solid, liquid, or gas) of the phase change material 310. In an embodiment, the first temperature sensor 315 may function as the phase detector 325 based on the measured temperature of the phase change material 310. For example, the phase change material 310 is a solid when the measured temperature of the phase change material 310 is below the melting point of the phase change material 310. The phase change material 310 is a liquid when the measured temperature of the phase change material 310 is above the melting point but below the boiling point of the phase change material 310. The phase change material 310 is a gas when the measured temperature of the phase change material 310 is above the boiling point of the phase change material 310. The phase change material 310 is a mixture of solid and liquid when the measured temperature of the phase change material 310 is equal to the melting point of the phase change material 310. The phase change material 310 is a mixture of liquid and gas when the measured temperature of the phase change material 310 is equal to the boiling point of the phase change material 310. As shown in FIG. 3, the thermal conductivity measurement system 300 may further include a display 370 showing the thermal conductivity of the sample 330 after step 140 of method 100 in FIG. 1 is implemented. In an embodiment, the thermal conductivity measurement system 300 includes one or more processors coupled with the first temperature sensor 315, the second temperature sensor 335, the third temperature sensor 360, the timer 327, and the phase detector 325 and configured to implement step 140 of method 100 in FIG. 1 to determine the thermal conductivity of the sample 330 using one or more equations to be discussed in great details below based on one or more measurements from the first temperature sensor 315, the second temperature sensor 335, the third temperature sensor 360, the timer 327, and the phase detector 325. The one more processors may be further configured to transmit the determined thermal conductivity to the display 370 for showing. In an embodiment, the one or more processors are located in a remote server or hardware platform (e.g., the hardware platform 1300) that is in communication with the first temperature sensor 315, the second temperature sensor 335, the third temperature sensor 360, the timer 327, and the phase detector 325.

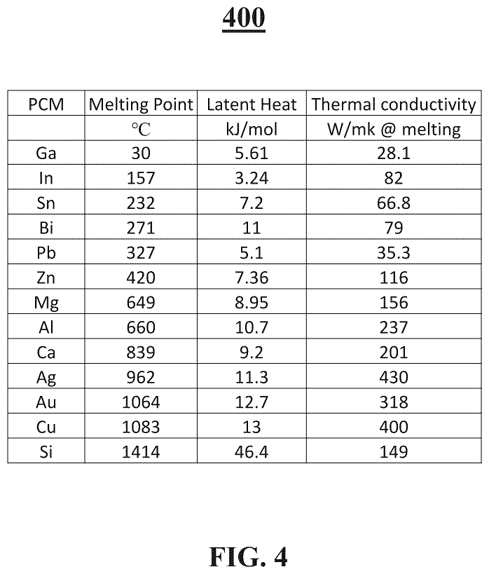

When or before implementing step 130 of method 100 in FIG. 1, the phase change material 310 may change a phase at the first temperature T₁, while the thermal source 340 may maintain a second temperature T₂. In an embodiment, the first temperature T₁ is lower than the second temperature T₂. As described above, the phase change material 310 and the thermal source 340 may be selected based on a specific, required temperature range for which the thermal conductivity of the sample is determined. FIG. 4 shows a table 400 including some examples of phase change materials 310 that may be used in a thermal conductivity measurement system 300. Although not shown in the table 400, the examples of the phase change materials 310 may further include, but are not limited to, eutectic alloys, such as a Copper-Tin (Cu—Sn) alloy, an Aluminum-Tin (Al—Sn) alloy, a Copper-Gold (Cu—Au) alloy, a Copper-Silver (Cu—Ag) alloy, a Tin-Zinc (Sn—Zn) alloy, and an Aluminum-Tin (Al—Sn) alloy.

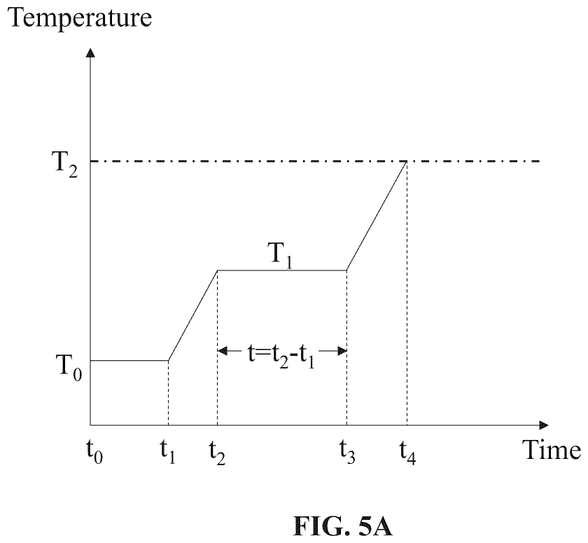

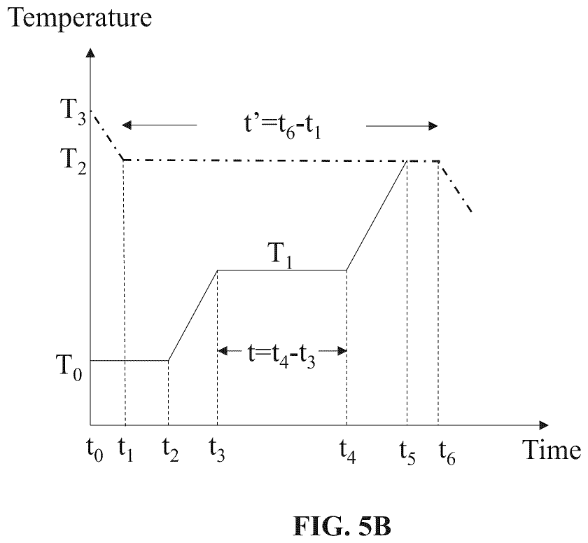

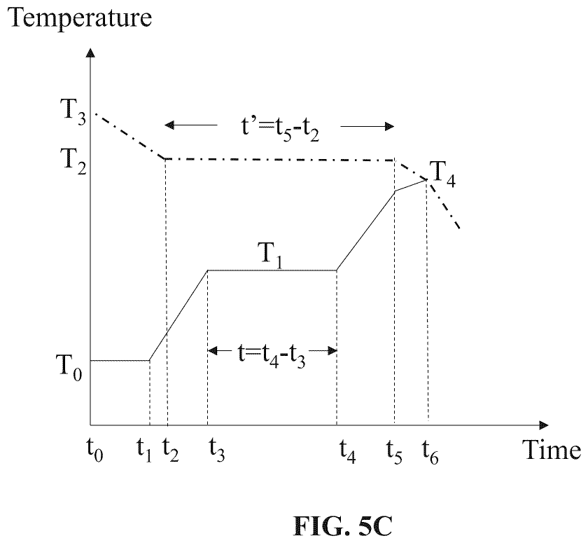

In an embodiment, the phase change material 310 is provided in a lower energy phase having a temperature lower than the first temperature T₁ when or before implementing step 120 of method 100 in FIG. 1, while the thermal source 340 maintains the second temperature T₂. For example, the phase change material 310 may be provided as a solid having a temperature below its melting point. As another example, the phase change material 310 may be provided as a liquid having a temperature below its boiling point. Because the thermal source 340 has a higher temperature than the phase change material 310, the thermal conduction occurs from the thermal source 340 to the phase change material 310 through the sample 330 to cause the phase change material 310 to transition from the lower energy phase to a higher energy phase at the first temperature T₁. In an embodiment, Step 130 in method 100 of FIG. 1 is implemented by the timer 327 in FIG. 3 to measure the phase transition period during which the phase change material 310 experiences the phase transition, for example, from a solid to a liquid, or from a liquid to a gas. To describe the thermal conductivity measurement process in greater clarity, the temperature changes with respect to time for the phase change material 310 (in a solid line) and the thermal source 340 (in a dash-dotted line) are shown in FIG. 5A. As shown, the thermal source 340 maintains a steady, constant temperature T₂. The phase change material 310 has an initial temperature of T₀ from time t₀ to time t₁, when the thermal conduction starts from the thermal source 340 to the phase change material 310 (for example, because of the sample 330 to be placed and in thermal contact with the phase change material 310 and the thermal source 340). The temperature of the phase change material 310 rises from T₀ at time t₁ to the phase change temperature T₁ at time t₂ when the phase change material 310 starts to transition from a lower energy phase to a higher energy phase while maintaining the phase change temperature T₁ from time t₂ to time t₃. During the phase transition period t=t₃−t₂, the phase change material 310 operates by storing energy from the thermal source 340 at a constant temperature T₁ when transitioning from the lower energy phase to the higher energy phase, for example, from solid to liquid, or from liquid to gas. The stored energy may be converted to a kinetic energy of the motion of atoms of the phase change material 310. The stored energy during the phase change at a constant temperature is referred to as a latent heat of the phase change material 310. In the example shown in FIG. 5A, the latent heat of the phase change material 310 is a difference of energy of the phase change material 310 at time t₃ and at time t₂. In an embodiment, the phase transition period t of the phase change material 310 is measured by the timer 327 in FIG. 3 at step 130 of method 100 in FIG. 1. After the phase change material 310 fully transitions to the higher energy phase at time t₃, the added energy from the thermal source 340 raises the temperature of the phase change material 310 until T₂ at time t₄ after which the phase change material 310 and the thermal source 340 have the same temperature. In an embodiment, the first temperature T₁ is the melting point of the phase change material 310. Accordingly, the phase change material 310 is a solid from time t₀ to time t₂, a mixture of solid and liquid during the phase transition period t from time t₂ to time t₃ and is a liquid after time t₃ when the temperature of the phase change material 310 is below the boiling point of the phase change material. In an embodiment, the first temperature T₁ is the boiling point of the phase change material 310. Accordingly, the phase change material 310 is a liquid from time t₀ to time t₂, a mixture of liquid and gas during the phase transition period from time t₂ to time t₃ and is a gas after time t₃. In an embodiment, the thermal source 340 may be a heater providing the constant temperature T₂. In an embodiment, the thermal source 340 may be a second phase change material coupled with a controlled heater 375 to keep the second phase change material at the constant temperature T₂. In an embodiment, the controlled heater 375 is a heating tape. In some embodiments, the second phase change material of the thermal source 340 may be the same as the phase change material 310 or different from the phase change material 310 with a phase change temperature no higher than T₁. As such, the controller heater 375 of the thermal source 340 may keep the second phase change material of the thermal source 340 in the higher energy phase at the constant temperature T₂. In some embodiments, the second phase change material of the thermal source 340 may be different from the phase change material 310 with a phase change temperature higher than T₁. The phase change temperature of the second phase change material in this example may be less than, equal to, or greater than the second temperature T₂.

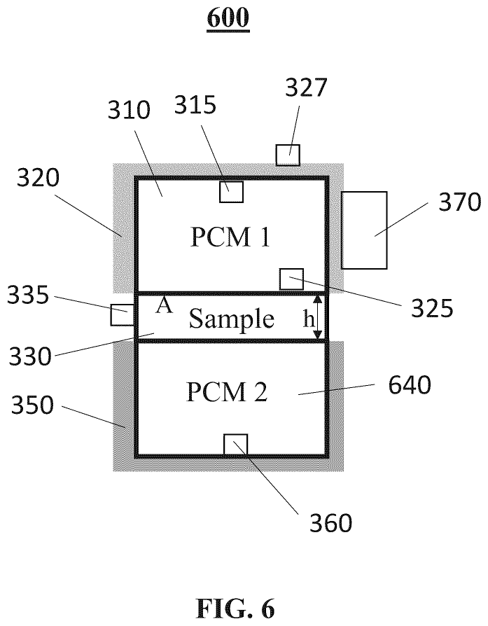

FIG. 6 shows an example of a thermal conductivity measurement system 600 including two different phase change materials 310, 640. The phase change material 310 in FIG. 3 is renamed to be a first phase change material 310. In an embodiment, the thermal source 340 in the thermal conductivity measurement system 300 is a phase change material. Accordingly, the thermal source 340 in the thermal conductivity measurement system 300 is changed to a second phase change material 640 in the thermal conductivity measurement system 600 in FIG. 6. In an embodiment, the second phase change material 640 maintains the second temperature T₂ during a phase transition at the second temperature T₂, which is the phase change temperature of the second phase change material 640. The second temperature T₂ may correspond to an upper bound of the temperature range for which the thermal conductivity of the sample 330 is determined. The second phase change material 640 may be selected accordingly based on the temperature range requirement. In some embodiments, the second phase change material 640 may be selected, for example, among the phase change materials in table 400 in FIG. 4.

To describe the thermal conductivity measurement process in greater clarity, the temperature changes with respect to time for the first phase change material 310 (in a solid line) and the second phase change material 640 (in a dash-dotted line) are shown in FIGS. 5B-5C. In both examples of FIGS. 5B and 5C, the first phase change material 310 maintains the first temperature T₁ during a first phase transition period t for transitioning from a lower energy phase to a higher energy phase, and the second phase change material 640 maintains the second temperature T₂ during a respective second phase transition period t′ that is longer than the first phase transition period t for transitioning from a higher energy phase to a lower energy phase. Specifically in FIG. 5B, the temperature of the second phase change material 640 falls from T₃ at time t₀ to T₂ at time t₁ when the second phase change material 640 starts transitioning from the higher energy phase to the lower energy phase (for example, from gas to liquid, or from liquid to solid). The second phase change material 640 then maintains the second temperature T₂ to time t₆ before falling. The second phase change material 640 operates by releasing energy at the second phase transition period t′=t₆−t₁ at the second phase change temperature T₂ when the phase change occurs, for example from the higher energy phase to the lower energy phase. The released energy during the second phase transition period may be converted from the kinetic energy of the motions of the atoms of the second phase change material 640. The latent heat of the second phase change material 640 is the difference between the energies of the second phase change material 640 at time t₁ and at time t₆. The first phase change material 310 has an initial temperature of T₀ from time t₀ to time t₂, when the thermal conduction starts from the second phase change material 640 to the first phase change material 310 and when the second phase change material 640 is a mixture of the lower energy phase and the higher energy phase during the phase transition. The temperature of the first phase change material 310 rises from T₀ at time t₂ to the first phase change temperature T₁ at time t₃ when the first phase change material 310 starts to transition from a lower energy phase to a higher energy phase while maintaining the first phase change temperature T₁ from time t₃ to time t₄. During the first phase transition period t=t₄−t₃, the first phase change material 310 operates by storing energy from the second phase change material 640 at a constant temperature T₁ when transitioning from the lower energy phase to the higher energy phase, for example, from solid to liquid, or from liquid to gas. The latent heat of the first phase change material 310 is a difference of energy of the first phase change material 310 at time t₄ and at time t₃. After the first phase change material 310 fully transitions to the higher energy phase at time t₄, the added energy from the second phase change material 640 raises the temperature of the first phase change material 310 until T₂ at time t₅ and remains at T₂ till time to after which the temperatures of the first phase change material 310 and the second phase change material 640 falls together.

As another example in FIG. 5C, the temperature of the second phase change material 640 falls from T₃ at time t₀ to the second phase change temperature T₂ at time t₂ when the second phase change material 640 starts transitioning from the higher energy phase to the lower energy phase (for example, from gas to liquid, or from liquid to solid), then maintains constant to time t₅ before falling. The second phase change material 640 operates by releasing energy at the second phase transition period t′=t₅−t₂ at the second phase change temperature T₂ when the phase change occurs, for example from the higher energy phase to the lower energy phase. The latent heat of the second phase change material 640 is the difference between the energies of the second phase change material 640 at time t₂ and at time t₅. The first phase change material 310 has an initial temperature of T₀ from time t₀ to time t₁, when the thermal conduction starts from the second phase change material 640 to the first phase change material 310. Different from FIG. 5B where the second phase change material 640 is a mixture of the lower energy phase and the higher energy phase when the thermal conduction starts at time t₁, FIG. 5C provides that the second phase change material 640 is fully in the higher energy phase at a temperature higher than the second phase change temperature T₂ when the thermal conduction starts. The temperature of the first phase change material 310 rises from T₀ at time t₁ to the first phase change temperature T₁ at time t₃ when the first phase change material 310 starts to transition from a lower energy phase to a higher energy phase while maintaining the first phase change temperature T₁ from time t₃ to time t₄. The first phase transition period t is equal to t₄−t₃. The latent heat of the first phase change material 310 is a difference of energy of the first phase change material 310 at time t₄ and at time t₃. After the first phase change material 310 fully transitions to the higher energy phase at time t₄, the added energy from the second phase change material 640 raises the temperature of the first phase change material 310 until T₄ at time to after which the temperatures of the first phase change material 310 and the second phase change material 640 falls together. Different from FIG. 5B where the temperature of the first phase change material 310 rises to T₂ before the first phase change material finishes the phase transition process, FIG. 5C provides that the first phase change material 310 fails to reach the same temperature as the second phase change material 640 before the second phase change material 640 completes the phase transition process.

In an embodiment, the first temperature T₁ in either FIG. 5B or FIG. 5C is the melting point of the first phase change material 310. Accordingly, the first phase change material 310 is a solid before the first phase transition period t at the first temperature T₁, a mixture of solid and liquid during the first phase transition period t at the first temperature T₁, and is a liquid after the first phase transition period t when the temperature of the first phase change material 310 is below the boiling point of the first phase change material 310. In an embodiment, the first temperature T₁ in either FIG. 5B or FIG. 5C is the boiling point of the first phase change material 310. Accordingly, the first phase change material 310 is a liquid before the first phase transition period t at the first temperature T₁, a mixture of liquid and gas during the first phase transition period t at the first temperature T₁, and is a gas after the first phase transition period t.

In an embodiment, the second temperature T₂ in either FIG. 5B or FIG. 5C is the melting point of the second phase change material 640. Accordingly, the second phase change material 640 is a liquid when below the boiling point of the second phase change material 640 before the second phase transition period t′ at the second temperature T₂, a mixture of solid and liquid during the second phase transition period t′ at the second temperature T₂, and is a solid after the second phase transition period t′. In an embodiment, the second temperature T₂ in either FIG. 5B or FIG. 5C is the boiling point of the second phase change material 640. Accordingly, the second phase change material 640 is a gas before the second phase transition period t′ at the second temperature T₂, a mixture of liquid and gas during the second phase transition period t at the first temperature T₂, and is a liquid after the second phase transition period t′.

In each of the examples associated with FIGS. 3, 5A-5C, and 6, the constant heat flux q can be further determined with respect to the phase change material 310 as:

$$q = \frac{{m}_{1} {H}_{1}}{t} \qquad ( 3 )$$

where m₁ is a mass of the phase change material 310 (or the first phase change material 310), H₁ is a latent heat of the phase change material 310 (or the first phase change material 310), and t is the phase transition period for which the phase change material 310 (or the first phase change material 310) experiences a phase change.

By plugging equation (3) to equation (2), the thermal conductivity of the sample 330 for a temperature range between T₁ and T₂ can be determined as:

$$k = \frac{{m}_{1} {H}_{1} h}{A ( {T}_{2} - {T}_{1} ) t} \qquad ( 4 )$$

In an embodiment, m₁, H₁, h, A. T₁ and T₂ in equation (4) are all known or easily obtainable constants. Accordingly, step 130 of method 100 in FIG. 1 may include measuring the phase transition period of the phase change material 310 (or the first phase change material 310) by the timer 327. Step 140 of method 100 in FIG. 1 may include determining the thermal conductivity of the sample, k, by plugging the measured phase transition period t to equation (4).

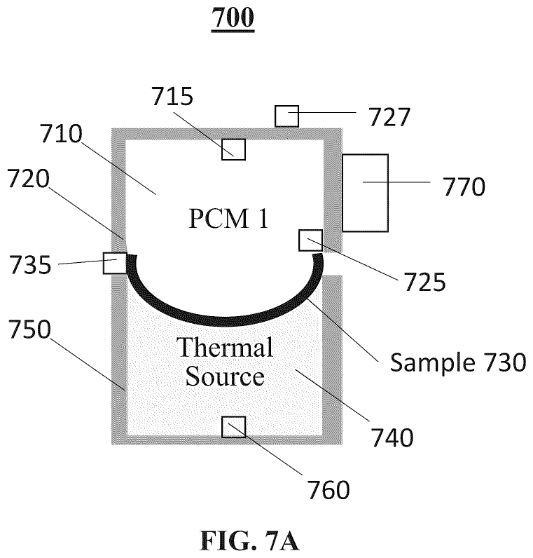

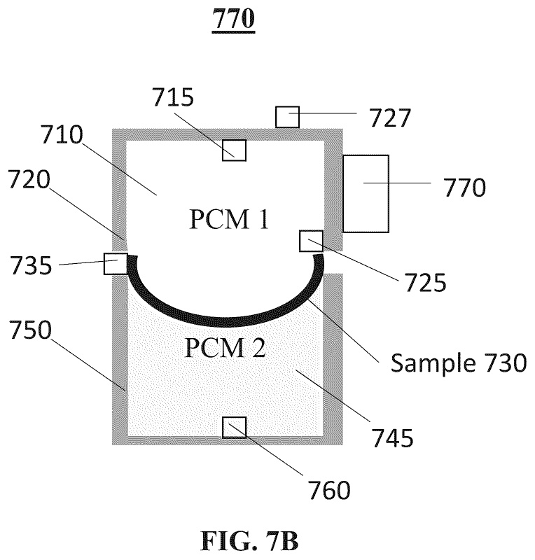

FIG. 7A shows another example of a thermal conductivity measurement system 700 for measuring a thermal conductivity of a sample 730. The thermal conductivity measurement system 700 is functionally similar to the thermal conductivity measurement system 300. The thermal conductivity measurement system 700 includes a first temperature sensor 715, a first insulator 720, a phase detector 725, a timer 727, a second temperature sensor 735, a second insulator 750, a third temperature sensor 760, a display 770, which are substantially similar to the first temperature sensor 315, a first insulator 320, a phase detector 325, a timer 327, a second temperature sensor 335, a second insulator 350, a third temperature sensor 360, and a display 370. In addition, the thermal conductivity measurement system 700 includes a phase change material 710 and a thermal source 740, which are substantially similar to the phase change material 310 and the thermal source 360 except for differences in shape. As shown, the sample 730 in FIGS. 7A-7B has a more complex shape than the sample 330 in FIG. 3. Specifically in FIGS. 7A-7B, the sample 730 has a curved shape. To ensure a good contact and accuracy in determining the thermal conductivity of the sample 730, the phase change material 710 and the thermal source 740 each have a curved shape that conforms to the curved shape of the sample 730 as shown in FIG. 7A. It is not challenging to conform the shape of the phase change material 710 or the thermal source 740 to the shape of the sample 730 when the phase change material 710 or the thermal source 740 is a liquid or gas. In an embodiment, the phase change material 710 or the thermal source 740 has a pre-formed shape that confirms with the shape of the sample 730 when the phase change material 710 or the thermal source 740 is a solid. In an embodiment, the phase change material 710 may be processed to have a shape that conforms to the shape of the sample 730 to have a good thermal contact with the sample 730. For example, the phase change material 710 may be first melted to liquid to be placed on the sample 730. When cooled down, the phase change material 710 becomes a solid having a curved shape that conforms to the shape of the sample 730. Sometimes, after cooled down, the phase change material 710 in the solid phase is combined with the sample. In addition or alternatively, the thermal source 740 may be melted to liquid with the sample 730 on top of the thermal source 740 in the liquid phase and below the phase change material 710.

In an embodiment, the thermal source 740 is a different phase change material than the phase change material 710 as shown in FIG. 7B. The thermal conductivity measurement system 770 in FIG. 7B includes the phase change material 710 (renamed to be a first phase change material 710 in FIG. 7B) and the second phase change material 745. The second phase change material 745 is substantially similar to the second phase change material 640 except for difference in shape. As described associated with FIGS. 5B, 5C, and 6, the first phase change material 310 may be provided initially in form of solid or liquid, and the second phase change material 745 may be provided initially in form of liquid, gas, mixture of liquid and gas, or mixture of solid and liquid before step 130 of method 100 in FIG. 1 is implemented.

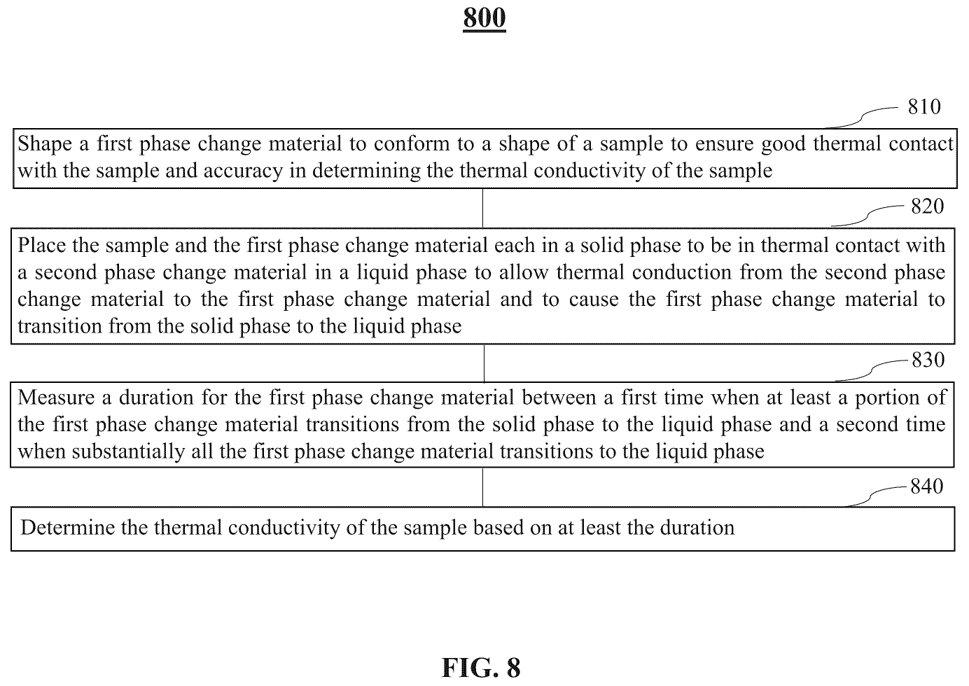

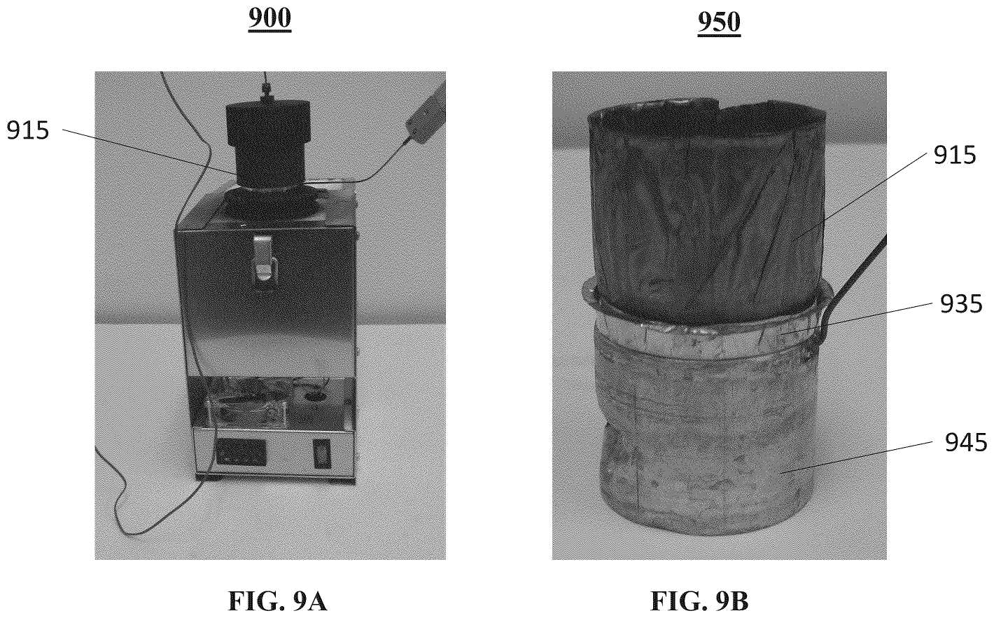

FIG. 8 is a flowchart for an example method 800 of measuring a thermal conductivity of a sample using two different phase change materials. In an embodiment, the sample may be the sample 330, 730. In an embodiment, one or more steps of method 800 may be performed using a furnace 900 as shown in FIG. 9A and a thermal conductivity measurement system 950 as shown in FIG. 9B. At step 810, a first phase change material is shaped to conform to a shape of a sample to ensure good thermal contact with the sample and accuracy in determining the thermal conductivity of the sample. The first phase change material may be the first change phase material 310, 710. In an embodiment, the first phase change material is shaped to conform to the shape of the sample. For example, when the sample is similar to the sample 730 having a curved shape, and the first phase change material may also have a curved shape that conforms to the curved shape of the sample 730 to ensure a good thermal contact between the sample and the first phase change material. In an embodiment, the first phase change material is shaped by supplying heat to the first phase change material having a first melting point and the second phase change material having a second melting point higher than the first melting point to melt the first phase change material and the second phase change material each to a liquid phase. For example, the first phase change material may be Tin (Sn) having a melting point of 232° C., and the second phase change material may be aluminum (Al) having a melting point of 660° C. The furnace 900 as shown in FIG. 9A is used to supply heat to melt Tin (Sn) in a thin wall metal cup 915 to liquid. The further 900 may be also used to melt the Aluminum (Al) in a graphite crucible 945 to liquid. Both the thin wall metal cup 915 and the graphite crucible 945 may have good thermal conductivities that allow efficient thermal conduction. After the Aluminum (Al) has been fully melted to liquid, the furnace 900 may be turned off or kept low heating power just to overcome heat loss for the Aluminum (Al) and maintain a relatively stable temperature in the graphite crucible 945. In an embodiment, the first phase change material is further shaped by placing at least a portion of the first phase change material in the liquid phase to the sample so that when cooled down the first phase change material transitions from the liquid phase to the solid phase and is combined with the sample. For example, at least a portion of the Tin (Sn) in the liquid phase may be placed on the sample 935 to allow Tin (Sn) after cooled down to the solid phase to have a shape that conforms to the shape of the sample 935. In some embodiments, the at least a portion of the Tin (Sn) is combined with the sample 935 after cooled down to a solid.

At step 820, the sample and the first phase change material each in the solid phase are placed to be in thermal contact with the second phase change material in the liquid phase to allow thermal conduction from the second phase change material to the first phase change material and to cause the first phase change material to transition from the solid phase to the liquid phase. For example, the sample combined with Tin (Sn) is placed to be in thermal contact with and on top of the liquid Aluminum (Al) to allow the thermal conduction from the liquid Aluminum (Al) to the liquid Tin (Sn) through the liquid sample. The thermal conduction may raise the temperature of the Tin (Sn) to its melting point of 232° C. and cause the Tin (Sn) to transition from the solid phase to the liquid phase at 232° C. In an embodiment, Tin (Sn) experiences the phase change from solid to the liquid phase at 232° C. when Aluminum (Al) is experiencing a phase change from liquid to solid at 660° C. In an embodiment, the temperature change for both Aluminum (Al) and Tin (Sn) is monitored and recorded.

At step 830, a duration for the first phase change material between a first time when at least a portion of the first phase changer material transitions from the solid phase to the liquid phase and a second time when substantially all the first phase change material transitions to the liquid phase is measured. In an embodiment, the measured duration is the phase transition period of Tin (Si).

At step 840, the thermal conductivity of the sample is determined based on the duration. In an embodiment, the thermal conductivity of the sample for the temperature range between the melting points of Tin (Sn), 232° C. and the melting point of Aluminum (Al), 660° C. is determined, for example, using equation (4) based on the measured duration at step 830.

FIGS. 10A-10D depict different examples of adjusting a temperature range for which a thermal conductivity of a sample is determined. Equation (4) calculates a thermal conductivity of a sample between constant temperatures at different sides of the sample, i.e., T₁ and T₂. Sometimes, it is desirable to determine the thermal conductivity for a different temperature range. However, it is difficult to adjust the constant temperatures T₁ and T₂ when the phase change material and the thermal source are selected and employed. One solution to this problem is to insert one or more reference structures between the phase change material and the thermal source. When the phase change material and the thermal source each maintain a respective constant temperature, the inserted one or more reference structures each have a respective known thermal conductivity. By changing the thickness of each of the one or more reference structures, the respective temperature difference from one side to another for each of the one or more reference structure may be adjusted. Accordingly, the temperature range for which the thermal conductivity of the sample may be adjusted. In an embodiment, the one or more reference structures have the same thermal conductivity. In an embodiment, the one or more reference structures have different thermal conductivities. In an embodiment, the one or more reference structures have the same thickness. In an embodiment, the one or more reference structures have different thicknesses. In an embodiment, the thermal conductivity of each of the one or more reference structures is known. In an embodiment, the one or more reference structures are one or more reference plates. In an embodiment, the one or more reference structures each have a shape that conform to the shape of the sample.

FIG. 10A shows an example of increasing the lower bound of the temperature range for which a thermal conductivity of a sample 1030 is determined by inserting a first reference structure 1020 between the phase change material 1010 and the sample 1030 in a thermal conductivity measurement system 1002. In an embodiment, the phase change material 1010, the sample 1030, and the thermal source 1040 may be substantially similar to the phase change material 310, 710, the sample 330, 730, and the thermal source 340, 740. In operation, the phase change material 1010 maintains a first temperature T₁ for the phase transition period, denoted by t, during which the phase change material 1010 transitions from a lower energy phase to a higher energy phase, for example, for solid to liquid or from liquid to gas. The thermal source 1040 maintains a second temperature T₂ for at least a duration greater than the phase transition period. In an embodiment, at least one of the phase transition period t or the temperature of the sample 1030, T during the phase transition period t is measured to determine the thermal conductivity of the sample 1030 in FIGS. 10A-10D.

Similar to the discussions associated with FIGS. 2, 3, and 5A-5C, and 6, the heat flux q can be expressed by equations (5)-(7):

$$q = \frac{mH}{t} \qquad ( 5 )$$

$$q = \frac{{k}_{r 1} A ( {T}_{r 1} - {T}_{1} )}{{h}_{r 1}} \qquad ( 6 )$$

$$q = \frac{k A ( {T}_{2} - {T}_{r 1} )}{h} \qquad ( 7 )$$

where m is a mass of the phase change material 1010, H is a latent heat of the phase change material 1010, t is a phase transition period of the phase change material 1010 at the first temperature T₁, kᵣ₁ is a thermal conductivity of the first reference structure 1020, hᵣ₁ is a thickness of the first reference structure 1020, Tᵣ₁ is a constant temperature of the interface between the first reference structure 1020 and the sample 1030, A is a cross section area of the sample 1030, h is a thickness of the sample 1030, T₁ is a constant temperature of the phase change material 1010, T₂ is a constant temperature of the thermal source 1040, and k is the thermal conductivity of the sample 1030 for an adjusted temperature range between Tᵣ₁ and T₂. Because the thermal conduction occurs from the thermal source 1040 to the phase change material 1010 through the sample 1030 and the first reference structure 1020 subsequently, the constant temperature of the side of the first reference structure facing the sample, Tᵣ₁ is higher than the constant temperature of the phase change material T₁.

The thermal conductivity, k of the sample 1030 for the adjusted temperature range between Tᵣ₁ and T₂ can be calculated based on equations (5) and (7):

$$k = \frac{mHh}{A ( {T}_{2} - {T}_{r 1} ) t} \qquad ( 8 )$$

Alternatively, the thermal conductivity k of the sample 1030 for the adjusted temperature range between Tᵣ₁ and T₂ can be calculated based on equations (6) and (7):

$$k = {k}_{r 1} \frac{h ( {T}_{r 1} - {T}_{1} )}{{h}_{r 1} ( {T}_{2} - {T}_{r 1} )} \qquad ( 9 )$$

FIG. 10B shows an example of decreasing the higher bound of the temperature range for which a thermal conductivity of the sample 1030 is determined by inserting a second reference structure 1035 between the thermal source 1040 and the sample 1030 in a thermal conductivity measurement system 1004. In an embodiment, the second reference structure 1035 and the first reference structure 1020 in FIG. 10A have the same thickness. In an embodiment, the second reference structure 1035 and the first reference structure 1020 in FIG. 10A have different thicknesses. In an embodiment, the second reference structure 1035 and the first reference structure 1020 in FIG. 10A have the same thermal conductivity. In an embodiment, the second reference structure 1035 and the first reference structure 1020 in FIG. 10A have different thermal conductivities.

Similar to the above discussions, the heat flux q can be expressed by equations (5), (10) and (11):

$$q = \frac{{k}_{r 2} A ( {T}_{2} - {T}_{r 2} )}{{h}_{r 2}} \qquad ( 10 )$$

$$q = \frac{kA ( {T}_{r 2} - {T}_{1} )}{h} \qquad ( 11 )$$

where kᵣ₂ is a thermal conductivity of the second reference structure 1035, hᵣ₂ is a thickness of the second reference structure 1035, Tᵣ₂ is a constant temperature of the interface between second reference structure 1035 and sample 1030, and k is the thermal conductivity of the sample 1030 for an adjusted temperature range between T₁ and Tᵣ₂. Because the thermal conduction occurs from the thermal source 1040 to the phase change material 1010 through the second reference structure 1035 and the sample 1030 subsequently, the constant temperature of the side of the second reference structure facing the sample, Tᵣ₂ is lower than the constant temperature of the thermal source T₂.

The thermal conductivity, k of the sample 1030 for the adjusted temperature range between T₁ and Tᵣ₂ can be calculated based on equations (5) and (11):

$$k = \frac{mHh}{A ( {T}_{r 2} - {T}_{1} ) t} \qquad ( 12 )$$

Alternatively, the thermal conductivity k of the sample 1030 for the adjusted temperature range between T₁ and Tᵣ₂ can be calculated based on equations (10) and (11):

$$k = {k}_{r 2} \frac{h ( {T}_{2} - {T}_{r 2} )}{{h}_{r 2} ( {T}_{r 2} - {T}_{1} )} \qquad ( 13 )$$

FIG. 10C shows an example of narrowing the temperature range for which a thermal conductivity of the sample 1030 is determined by inserting the first reference structure 1020 between the phase change material 1010 and the sample 1030, and the second reference structure 1035 between the thermal source 1040 and the sample 1030 in a thermal conductivity measurement system 1006.

Similar to the above discussions, the heat flux q can be expressed by equations (5), (14) (15) and (16):

$$q = \frac{{k}_{r 1} A ( {T}_{r 1} - {T}_{1} )}{{h}_{r 1}} \qquad ( 14 )$$

$$q = \frac{k A ( {T}_{r 2} - {T}_{r 1} )}{h} \qquad ( 15 )$$

$$q = \frac{{k}_{r 2} A ( {T}_{2} - {T}_{r 2} )}{{h}_{r 2}} \qquad ( 16 )$$

where k is the thermal conductivity of the sample 1030 for an adjusted temperature range between Tᵣ₁ and Tᵣ₂. Because the thermal conduction occurs from the thermal source 1040 to the phase change material 1010 through the second reference structure 1035, the sample 1030, and the first reference structure 1020, subsequently, the constant temperature of the interface between the second reference structure and the sample, Tᵣ₂ is lower than the constant temperature of the thermal source T₂, and the constant temperature of the interface between the first reference structure and the sample, Tᵣ₁ is higher than the constant temperature of the phase change material T₁.

The thermal conductivity, k of the sample 1030 for the adjusted temperature range between Tᵣ₁ and Tᵣ₂ can be calculated based on equations (5) and (15):

$$k = \frac{mHh}{A ( {T}_{r 2} - {T}_{r 1} ) t} \qquad ( 17 )$$

Alternatively, the thermal conductivity k of the sample 1030 for the adjusted temperature range between Tᵣ₁ and Tᵣ₂ can be calculated based on equations (14) and (15):

$$k = {k}_{r 1} \frac{h ( {T}_{r 1} - {T}_{1} )}{{h}_{r 1} ( {T}_{r 2} - {T}_{r 1} )} \qquad ( 18 )$$

Alternatively, the thermal conductivity k of the sample 1030 for the adjusted temperature range between Tᵣ₁ and Tᵣ₂ can be calculated based on equations (15) and (16):

$$k = {k}_{r 2} \frac{h ( {T}_{2} - {T}_{r 2} )}{{h}_{r 2} ( {T}_{r 2} - {T}_{r 1} )} \qquad ( 19 )$$

In an embodiment, the thermal source 1040 in FIG. 10C is a phase change material as shown in FIG. 10D, in which the phase change material 1010 is renamed to a first phase change material 1010, and the thermal source 1040 is replaced by a second phase change material 1045 having a phase change temperature of T₂ in a thermal conductivity measurement system 1050. In an embodiment, the first phase change material 1010 and the second phase change material 1045 may be substantially similar to the first phase change materials 310, 710 and the second phase change material 640, 745. The thermal conductivity, k of the sample 1030 for the adjusted temperature range between Tᵣ₁ and Tᵣ₂ can be calculated based on equation (17), (18) or (19).

In an embodiment, each of the thermal conductivity measurement systems 1002, 1004, 1006, 1050 includes one or more sensors similar to the first temperature sensor 315, the second temperature sensor 335, the third temperature sensor 360, the timer 327, and the phase detector 325 in FIG. 3 to perform one or more measurements for determining the thermal conductivity of the sample 1030, for example at step 130 of method 100 in FIG. 1.

FIG. 11 is a schematic diagram of an example thermal conductivity measurement system 1100 configured to determine a thermal conductivity of a solid material sample 1130 having a tube structure. As shown in FIG. 11, the thermal conductivity measurement system 1100 includes a phase change material 1110, a thermal source 1140 and a container 1120 with a controlled heater 1125 coupled to the thermal source 1140. In this example, the solid material sample 1130 has a tube structure. Although not shown, the thermal conductivity measurement system 1100 may also include a display similar to the display 370 to show the determined thermal conductivity of the solid material sample 1130. The thermal conductivity measurement system 1100 may further include one or more sensors similar to the first temperature sensor 315, the second temperature sensor 335, the third temperature sensor 360, the timer 327, and the phase detector 325 in FIG. 3 to perform one or more measurements for determining the thermal conductivity of the solid material sample 1130, for example, at step 130 of method 100 in FIG. 1. In an embodiment, the phase change material 1110 and the thermal source 1140 may be substantially similar to the phase change material 310, 710, 1010 and the thermal source 340, 740, 1040 except for differences in shape. In an embodiment, the phase change material 1110 experiences a phase change at a first temperature T₁. In an embodiment, the controlled heater 1125 is configured to supply heat to the thermal source 1140 to cause the thermal source 1140 to maintain at a second temperature T₂ higher than T₁. In an embodiment, the thermal conductivity measurement system 1100 does not necessarily include an insulator because the heat flow inward. In an embodiment, the thermal source 1140 is a phase change material different than the phase change material 1110. In an embodiment, the phase change material of the thermal source 1140 has a higher phase change temperature (e.g., a melting point or a boiling point) than the phase change material 1110. In an embodiment, the thermal source 1140 is the phase change material 1110 coupled with the controlled heater 1125 that keeps the phase change material of the thermal source 1140 in a higher energy state (e.g., liquid or gas) maintaining the second temperature T₂. In an embodiment, the controlled heater 1125 is a heating tape. In an embodiment, the container 1120 is a granite crucible. As shown the solid material sample 1130 has a tube structure. Accordingly, the thermal source 1140 may also have a tube structure, while the phase change material 1110 may have a cylinder shape (as shown in FIG. 11) that conforms to the shape of the solid material sample 1130 to ensure a good thermal contact and accuracy in determining the thermal conductivity of the solid material sample 1130. In an embodiment, the phase change material 1110 may be pre-formed to have the cylinder shape that conforms to the tube shape of the solid material sample 1130. In an embodiment, the phase change material 1110 may be processed to have the cylinder shape that conforms to the tube shape of the solid material sample 1130 through a similar process to step 810 of method 800 in FIG. 8. For example, the phase change material 1110 may be Tin (Sn), and the solid material sample 1130 may have a quartz tube shape. The phase change material 1110 may be melted fully by a furnace, for example, the furnace 900 to liquid Tin (Sn) and placed on the surface of the solid material sample 1130. When cooled down, the liquid Tin (Sn) may become a solid cylinder structure including a portion that is in contact with and conforms to the tube shape at the contact location of the solid material sample 1130 to ensure a good thermal contact with the solid material sample 1130. Sometimes, the phase change material 1110 having the cylinder shape may be combined to the solid material sample 1130. In addition, the thermal source 1140 may also be Tin (Sn) and melted fully by a furnace, for example, the furnace 900 to liquid Tin (Sn) that is coupled to the controlled heater 1125 (for example, a heating tape) that allows the liquid Tin (Sn) to maintain in liquid and at the second temperature T₂ that is higher than T₁. The solid material sample 1130 having the quartz tube shape and combined with the phase change material 1110 is placed to be in thermal contact with the thermal source 1140 in form of liquid Tin (Sn) at the second temperature T₂ to cause the thermal conduction occurs from the thermal source 1140 to the phase change material 1110 through the solid material sample 1130. The thermal conduction may raise the temperature of the phase change material 1110 to the first temperature T₁ to change a phase, for example, from a solid to a liquid at T₁. In an embodiment, the one or more sensors of the thermal conductivity measurement system 1100 may be used to measure and monitor the temperatures of the phase change material 1110 and the thermal source 1140. In an embodiment, the phase transition period t of the phase change material 1110 for which the phase change material 1110 transitions from a lower energy phase to a higher energy phase may be measured, for example, by the timer that is similar to the timer 327, 727.

The heat flux q can be expressed by equations (20) and (21):

$$q = \frac{2 π kL ( {T}_{2} - {T}_{1} )}{ln ( \frac{{r}_{o}}{r i} )} \qquad ( 20 )$$

$$q = \frac{mH}{t} = \frac{π {r}_{i}^{2} L ρ H}{t} \qquad ( 21 )$$

where m is a mass of the phase change material 1110, H is a latent heat of the phase change material 1110, t is a phase transition period of the phase change material 1110 at the first temperature T₁, ρ is a density of the phase change material 1110, L is a length of phase change material 1110, rᵢ is an inner radius of the tube shape of the sample 1130, and rₒ is an outer radius of the tube shape of the sample 1130, T₁ is a constant temperature of the phase change material 1110, T₂ is a constant temperature of the thermal source 1140, and k is the thermal conductivity of the solid material sample 1130 for the temperature range between T₁ and T₂.

The thermal conductivity, k of the solid material sample 1130 for the temperature range between T₁ and T₂ can be calculated based on equations (20) and (21):

$$k = \frac{ρ {r}_{i}^{2} Hln ( \frac{{r}_{o}}{{r}_{i}} )}{2 t ( {T}_{2} - {T}_{1} )} \qquad ( 22 )$$

In an embodiment, the phase change material 1110 and the thermal source 1140 may be arranged differently such as the phase change material is placed between the container 1120 and the solid material sample 1130, and the thermal source 1140 has the cylinder shape placed inside the tube structure of the solid material sample 1130. In this arrangement, the thermal conductivity measurement system 1100 may include an insulator outside the container 1120 to prevent heat loss because heat flows outward from the thermal source 1140 to the phase change material 1110.

FIG. 12 is a schematic diagram of an example thermal conductivity measurement system 1200 configured to determine a thermal conductivity of a sample 1230. Different from the solid material sample 1130 in FIG. 11, the sample 1230 is a liquid or a gas contained in or directed to flow in a fluid conduit 1205 between and in thermal contact with the phase change material 1110 and the thermal source 1140 in the thermal conductivity measurement system 1200. Sometime, the sample 1230 is also referred to as a liquid or gas sample 1230. In an embodiment, the fluid conduit 1205 is a tube structure. In an embodiment, the fluid conduit 1205 is a double thin wall tube. The fluid conduit 1205 has a good thermal conductivity that puts the liquid or gas sample 1230 in thermal contact with the phase change material 1110 and the thermal source 1140 and allows the thermal conduction from the thermal source 1140 to the phase change material 1110 although the fluid conduit 1205 physically separates the liquid or gas sample 1230 from both the phase change material 1110 and the thermal source 1140.

In an embodiment, the thermal conductivity measurement system 1200 includes one or more sensors similar to the first temperature sensor 315, the second temperature sensor 335, the third temperature sensor 360, the timer 327, and the phase detector 325 in FIG. 3 to perform one or more measurements for determining the thermal conductivity of the liquid or gas sample 1230, for example, at step 130 of method 100 in FIG. 1.

In an embodiment, each of the thermal conductivity measurement systems 600, 700, 770, 1002, 1004, 1006, 1050, 1100, and 1200 include one or more processors coupled to the one or more sensors and similar to the one or more processors in the thermal conductivity measurement system 300 as described above.

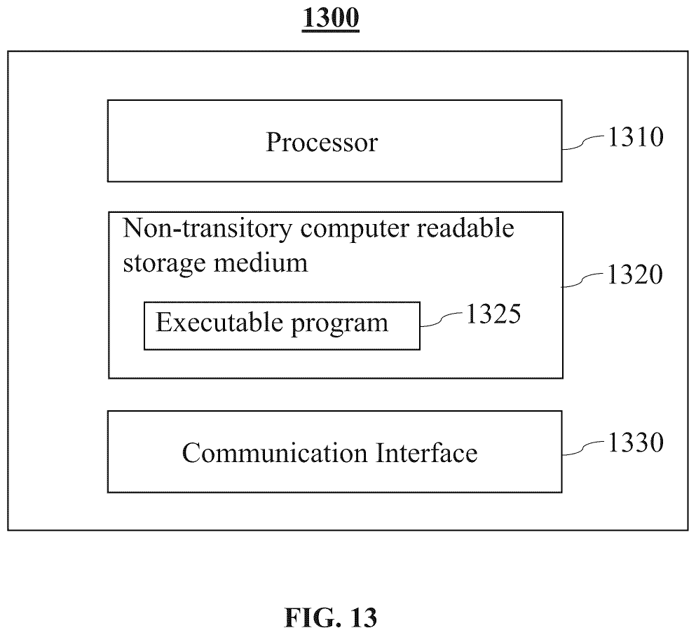

FIG. 13 shows an example of a hardware platform 1300 configured to implement some of the methods 100, 800 described in the present disclosure. The hardware platform 1300 may include one or more processors 1310 that can execute an executable program 1325 to instruct and control one or more manufacturing tools to implement a method. The hardware platform 1300 may include a non-transitory computer readable storage medium 1320 that may be used to store one or more executable programs 1325 (i.e., executable computer codes) and/or store data. The hardware platform 1300 may further include a communication interface 1330. For example, the communication interface 1330 may implement one or more wired or wireless communication protocols (Ethernet, LTE, Wi-Fi, Bluetooth, and so on). The hardware platform 1300 may be used for implementing the offline server or the online serve in communication with the one or more thermal conductivity measurement systems 300, 600, 700, 770, 1002, 1004, 1006, 1050, 1100, 1200 as described herein. In some embodiments, the one or more processors 1310 may be in communication with one or more sensors of the thermal conductivity measurement systems 300, 600, 700, 770, 1002, 1004, 1006, 1050, 1100, 1200 through the communication interface 1330. In some embodiment, the one or more processors 1310 may be configured to determine the thermal conductivities of the samples based on one or more measurements performed by the one or more sensors according to equations (4), (8), (9), (12), (13), (17)-(19), and (22) that may be included in the executable programs 1325 stored in the non-transitory computer readable storage medium 1320.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various components in the embodiments described in this patent document should not be understood as requiring such separation in all embodiments.

Only a few implementations and examples are described, and other implementations enhancements and variations can be made based on what is described and illustrated in this patent document.

What is claimed is:

1. A method of determining a thermal conductivity of a sample, comprising:
controlling a thermal source to increase a temperature of the thermal source to an elevated temperature above a phase change temperature of a phase change material;
placing the sample between and in thermal contact with the phase change material at an initial temperature below the phase change temperature and the thermal source at the elevated temperature to allow a thermal conduction from the thermal source to the phase change material through the sample to increase the initial temperature of the phase change material to the phase change temperature to cause the phase change material to transition from a first phase to a second phase at the phase change temperature;
performing a measurement on at least one of the sample or the phase change material; and
determining the thermal conductivity of the sample based on the measurement.

2. The method of claim 1, wherein the phase change material maintains the phase change temperature for a first phase transition period to transition from the first phase to the second phase.

3. The method of claim 2, wherein the thermal source is at a constant temperature that is equal to or below the elevated temperature during the first phase transition period and for at least a second phase transition period longer than the first phase transition period.

4. The method of claim 1, further comprising shaping the phase change material to conform to a shape of the sample to ensure good thermal contact with the sample and accuracy in determining the thermal conductivity of the sample.

5. The method of claim 1, wherein the phase change material has a curved shape to conform to a curved shape of the sample to ensure good thermal contact with the sample and accuracy in determining the thermal conductivity of the sample.

6. The method of claim 5, wherein the thermal conductivity of the sample is determined by:
$$k = \frac{ρ {r}_{i}^{2} Hln ( \frac{{r}_{o}}{{r}_{i}} )}{2 ( {T}_{2} - {T}_{1} ) t} ,$$
where k is the thermal conductivity of the sample, ρ is a density of the phase change material, H is a latent heat of the phase change material, r₁ is an inner radius of the curved shape of the sample, r₀ is an outer radius of the curved shape the sample, T₁ is the phase change temperature of the phase change material, T₂ is a constant temperature of the thermal source when the phase change material transitions from the first phase to the second phase at the phase change temperature, and t is the first phase transition period for the phase change material to transition from the first phase to the second phase.

7. The method of claim 6, wherein the sample is a solid material sample having a tube shape and the phase change material is shaped to include a portion that is in contact with and conforms to the tube shape at a contact location of the solid material sample.

8. The method of claim 1, wherein the sample is a liquid or gas and is directed to flow in a fluid conduit between and in thermal contact with the thermal source and the phase change material.

9. The method of claim 2, wherein the step of performing the measurement on the at least one of the sample or the phase change material comprises measuring the first phase transition period for the phase change material between a first time when at least a portion of the phase change material transitions from the first phase to the second phase, and a second time when substantially all the phase change material transitions to the second phase, and wherein the thermal conductivity of the sample is determined by:
$$k = \frac{{m}_{1} {H}_{1} h}{A ( {T}_{2} - {T}_{1} ) t} ,$$
where k is the thermal conductivity of the sample, m₁ is a mass of the phase change material, H₁ is a latent heat of the phase change material, h is a thickness of the sample, A is an area of the sample, T₁ is the phase change temperature of the phase change material, T₂ is a constant temperature of the thermal source when the phase change material transitions from the first phase to the second phase at the phase change temperature, and t is the first phase transition period for the phase change material to transition from the first phase to the second phase.

10. The method of claim 3, wherein the thermal source includes a second phase change material having a second phase change temperature.

11. The method of claim 3, further comprising:
placing a reference structure between the sample and one of the thermal source and the phase change material in a way that the reference structure is in thermal contact with the sample and the one of the thermal source and the phase change material; and
measuring a reference temperature of the reference structure during the first phase transition period to determine a thermal conductivity of the sample between the reference temperature of the reference structure and either the phase change temperature of the phase change material or the constant temperature the thermal source during the first phase transition period of the phase change material.

12. The method of claim 1, further comprising:
placing a first reference structure in thermal contact with the sample and between the sample and the phase change material;
placing a second reference structure between the sample and the thermal source to be in thermal contact with the sample and the thermal source; and
measuring a first reference temperature of the first reference structure and a second reference temperature of the second reference structure to determine a thermal conductivity of the sample between the first reference temperature of the first reference structure and the second reference temperature of the second reference structure.

13. The method of claim 12, wherein the thermal conductivity of the sample between the first reference temperature and the second reference temperature is determined by one of following expressions:
$$k = \frac{{k}_{r 2} ( {T}_{2} - {T}_{r 2} ) h}{{h}_{r 2} ( {T}_{r 2} - {T}_{r 1} )} , k = \frac{{k}_{r 1} ( {T}_{r 1} - {T}_{1} ) h}{{h}_{r 1} ( {T}_{r 2} - {T}_{r 1} )} , or k = \frac{mHh}{A ( {T}_{r 2} - {T}_{r 1} ) t} ,$$
where k is the thermal conductivity of the sample, kᵣ₁ is a thermal conductivity the first reference structure, kᵣ₂ is a thermal conductivity of the first reference structure, m is a mass of the phase change material, H is a latent heat of the phase change material, A is an area of the sample, h is a thickness of the sample, hᵣ₁ is a thickness of the first reference structure, hᵣ₂ is a thickness of the second reference structure, T₁ is the phase change temperature of the phase change material, T₂ is the constant temperature of the thermal source, Tᵣ₁ is a temperature of a first interface between the first reference structure and the sample, Tᵣ₂ is a temperature of a second interface between the second reference structure and the sample, and t is a first phase transition period for the phase change material to transition from the first phase to the second phase.

14. A system of determining a thermal conductivity of a sample, comprising:
a first phase change material configured to transition from a first phase to a second phase at a phase change temperature;
a thermal source configured to maintain a constant temperature higher than the phase change temperature, wherein the phase change material and the thermal source are placed on different sides of the sample to allow a thermal conduction from the thermal source to the phase change material and cause the phase change material to transition from the first phase to the second phase;
one or more sensors coupled to the phase change material and configured to perform a measurement on at least one of the sample or the phase change material; and
a processor coupled to the one or more sensors and configured to determine the thermal conductivity of the sample based on at least the measurement on the at least one of the sample or the phase change material.

15. The system of claim 14, wherein at least one of the thermal source or the phase change material has a shape that conforms to a shape of the sample to ensure good thermal contact with the sample and accuracy in determining the thermal conductivity of the sample.

16. The system of claim 14, wherein one of the thermal source or the phase change material has a cylinder shape.

17. The system of claim 14, wherein the thermal source is a second phase change material having a second phase change temperature equal to the constant temperature.

18. A method of determining a thermal conductivity of a sample, comprising:
shaping a first phase change material to conform to a shape of the sample to ensure good thermal contact with the sample and accuracy in determining the thermal conductivity of the sample;
placing the sample and the first phase change material each in a solid phase to be in thermal contact with a second phase change material in a liquid phase to allow thermal conduction from the second phase change material to the first phase change material and to cause the first phase change material to transition from the solid phase to the liquid phase;
measuring a duration for the first phase change material between a first time when at least a portion of the first phase change material transitions from the solid phase to the liquid phase and a second time when substantially all the first phase change material transitions to the liquid phase; and
determining the thermal conductivity of the sample based on at least the duration.

19. The method of claim 18, wherein the step of shaping the first phase change material to conform to the shape of the sample comprises:
supplying heat to the first phase change material having a first melting point and the second phase change material having a second melting point higher than the first melting point to melt the first phase change material and the second phase change material each to the liquid phase; and
placing at least a portion of the first phase change material in the liquid phase to the sample so that when cooled down the first phase change material transitions from the liquid phase to the solid phase and is combined with the sample.

20. The method of claim 18, wherein the thermal conductivity of the sample between the first melting point and the second melting point is determined by:
$$k = \frac{{m}_{1} {H}_{1} h}{A ( {T}_{2} - {T}_{1} ) t} ,$$
where k is the thermal conductivity of the sample, m₁ is a mass of the first phase change material, H₁ is a latent heat of the first phase change material, h is a thickness of the sample, A is an area of the sample, T₁ is the first melting point of the first phase change material, T₂ is the second melting point of the second phase change material, and t is the measured duration for the first phase change material to transition from the solid phase to the liquid phase, and wherein the first phase change material is Tin (Sn), lead (Pb), bismuth (Bi), a eutectic copper-silver (Cu—Ag) alloy, silver (Ag), cooper (Cu), or Silicon (Si).
